(19) United States
(12) Patent Application Publication
(10) Pub. No.: US 2004/0193487 A1
(43) Pub. Date: Sep. 30, 2004

(54) Secure promotions

(75) Inventors: William J. Purcell, San Ramon, CA (US); Edward M. Martin, Ripon, CA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Coolsavings, Inc.

(21) Appl. No.: 10/677,555

(22) Filed: Oct. 2, 2003

Related U.S. Application Data
(60) Provisional application No. 60/416,981, filed on Oct. 8, 2002.

(51) Int. Cl. G06F 17/60

(52) U.S. Cl. 705/14

(57) ABSTRACT

Novel apparatus and methods for secure promotions are disclosed. A unique identification code is utilized to validate promotions securely. The invention provides an efficient, quick, secure, and simple to implement technique for provision of promotions, in part, by utilizing novel and secure techniques.

### CROSS-REFERENCE TO RELATED APPLICATIONS

This application claims priority from Provisional Application No. 60/416,981, entitled “Secure Promotions,” filed Oct. 2, 2002.

### BACKGROUND OF THE INVENTION

1. Field of the Invention

The present invention relates generally to secure promotions and, more particularly, to secure apparatus and methods for use in conjunction with provision of promotions through a computer network, such as the Internet or an intranet.

2. Description of the Related Art

Coupon fraud has always been a real issue posing problems for product promoters and the coupon industry in general. The fraud associated with redemption of non authorized coupons is estimated to be in the billions annually in the United States alone. Historically, the printing methods employed by the traditional free standing insert (FSI) industry have been among the largest barriers to fraud, as their common approach was well recognized by retail personnel, and variations in printing and paper were frequently spotted at the checkout stand. Criminals could take high value coupons from FSI's and reproduce them on expensive, four color presses, or using expensive printing equipment, make their own counterfeit coupons. To combat this, the industry generally followed the practice of distributing coupons on familiar FSI paper stock with vivid colors and printing on both sides. These steps have made it significantly expensive for fraudulent duplication and forgery efforts, thus generally leaving the bulk of this type of mal redemption to professional criminals.

At the same time, the growth of the Internet has provided an enormous information and service resource to the millions of computer users around the world. One of these services is user printed coupons. With the new technology, new risks and issues are presented. For example, the user printed coupons create a new problem better known as non authorized promotions submitted to retailers (NAPSTRs).

NAPSTRs are generally defined as Internet based promotions with the following characteristics: (a) delivered via the Internet such as through a Web site; (b) printed by a user on a printer device in the user's control; (c) third party offered and retailer authenticated and paid for (traditionally, the third party issuer has been a consumer packaged goods (CPG) manufacturer and personnel from the retailer are required to authenticate the veracity of an offer at the time of checkout); and (d) independently cleared promotions (where a clearinghouse provides a number of services supporting marketers who issue traditional and Internet based coupons and the retailers who redeem them, including the tracking of fraudulently submitted coupons).

Internet based promotions offer benefits to consumers with access to the Internet. For example, users can print coupons just prior to their shopping trip. These coupons can be targeted based on the user's profile and location. Also, by having the user print the coupon on a local printer utilizing the user's paper and supplies, coupon marketers may achieve lower distribution costs.

With these additional benefits, however, come many additional risks including the following:

1. If a NAPSTR can be printed on a computer, it can be changed by a user. For examples, the user may redirect its computer output to a file, instead of a printer, and then modify that file accordingly. Moreover, user altered NAPSTRs appear identical to legitimate on line coupons. Thus, it is very easy for a NAPSTRs criminal to create “look a likes” to legitimate online user printed coupons.

2. Identifying the veracity of a NAPSTR is difficult because retailers would have to rely on cash register clerks for checking coupons for authenticity. This is especially a difficult task when the coupons are printed on regular stock paper, found in most homes. Aside from the fraud costs, it is estimated that the training and communication costs to the retail industry could amount to multiple millions of dollars of expense per year should NAPSTRs practices become widespread.

3. Knowing that fraud occurred after the fact will not prevent it. Most current systems for provision of coupons require post redemption processing. As a result, a NAPSTR may be redeemed without any precautions. In fact, a sponsor often does not find out about any fraudulent use until after the coupons are redeemed. Generally, NAPSTRs may be identified through an indicia printed on the coupon. These types of indicia are read only after a coupon reaches the clearinghouses, often weeks after the crime has been committed. In the event that the criminal was brazen enough to alter or reproduce a NAPSTR but not alter the user identification indicia, the coupon chain will be required to seek retribution from the identified user. This process is risky and cumbersome, in part, because of the lengthy and costly legal process involved. Also, the user may have registered under a fictitious name which may render the identification indicia useless.

Further information about secure provision of promotions can be found in U.S. Pat. No. 5,907,830, issued to Engel et al., and assigned to ADS Alliance Data Systems, Inc., the assignee of the present application, which is hereby incorporated herein by reference in its entirety for all purposes.

Therefore, what is needed is a simple to implement, inexpensive, and relatively fast, efficient, flexible, and secure solution for provision of promotions utilizing mostly existing technology already present in most stores via a computer network, such as the Internet or an intranet.

### BRIEF SUMMARY OF THE INVENTION

According to the present invention, a technique is disclosed for provision of secure promotions. In an embodiment, a unique identification code is utilized to validate promotions securely. The invention provides an efficient, quick, secure, and simple to implement technique for provision of promotions, in part, by utilizing novel and secure techniques.

In a further embodiment, a method of providing a promotion to a user is disclosed. The method includes the steps of providing the user with the promotion and determining whether the user has selected the promotion. If the user has selected the promotion, a retailer is informed about the selected promotion. The method further includes the step of determining whether a selected promotion is being redeemed at the retailer. If the selected promotion is being redeemed at the retailer, it is determined whether the selected promotion corresponds to the promotion being redeemed. If the selected promotion corresponds to the promotion being redeemed, the method provides the user with the promotion.

In a further embodiment, the act of determining whether the selected promotion corresponds to the promotion being redeemed includes: checking a first portion of a promotion identifier; if the first portion of the promotion identifier matches a target code, extracting a second portion of the promotion identifier; and accessing information within an item record associated with the second portion of the promotion code and including information regarding the promotion.

In yet another embodiment, a system for provision of a secure promotion to a user is disclosed. The system includes a user location configured to provide the user with access to the secure promotion, a service location coupled to the user location, a retailer location coupled to the service location, and a unique id code associated with the secure promotion. The service location is configured to provide the secure promotion to the user for selection. The retailer location is configured to receive the secure promotion. The unique id code can have first and second portions. The first portion of the unique id code indicates whether the secure promotion is a special promotion and the second portion of the unique id code indicates a link to an item record. The item record has fields comprising data regarding an item associated with the secure promotion. The user can receive benefits of the secure promotion by providing the unique id code to the retailer.

Further understanding of the nature and advantages of the invention may be realized by reference to the remaining portions of the specification and drawings.

### BRIEF DESCRIPTION OF THE SEVERAL VIEWS OF THE DRAWINGS

A better understanding can be obtained when the following detailed description of several disclosed embodiments is considered in conjunction with the following drawings in which

FIG. 1 is an exemplary illustration of a sample bar code 100 in accordance with the number system character (NSC) scheme;

FIG. 2 is a simplified exemplary block diagram of a computer system in which the present invention may be embodied;

FIG. 3 is a simplified exemplary block diagram of a promotion system 300 in accordance with an embodiment of the present invention;

FIG. 4 is a simplified exemplary flow diagram of a method of secure promotion processing 400 in accordance with an embodiment of the present invention;

FIG. 5 is a simplified exemplary block diagram of a secure promotion delivery system 500 in accordance with an embodiment of the present invention;

FIG. 6 is a simplified exemplary flow diagram of a method of secure promotion delivery 600 in accordance with an embodiment of the present invention;

FIG. 7 is a simplified exemplary block diagram of a secure promotion redemption system 700 in accordance with an embodiment of the present invention;

FIG. 8 is a simplified exemplary illustration of a secure NSC bar code 800 for a sample certificate in accordance with an embodiment of the present invention; and

FIG. 9 is a simplified exemplary block diagram of an item record 900 in accordance with embodiments of the present invention.

### DETAILED DESCRIPTION OF THE INVENTION

The present invention will now be described in reference to several embodiments that operate as secure promotions apparatus and methods. Specifically, examples will be described which illustrate particular features of the invention. The present invention, however, is not limited to any particular features nor limited by the examples described herein. Therefore, the descriptions of the embodiments that follow are for purposes of illustration and not limitation.

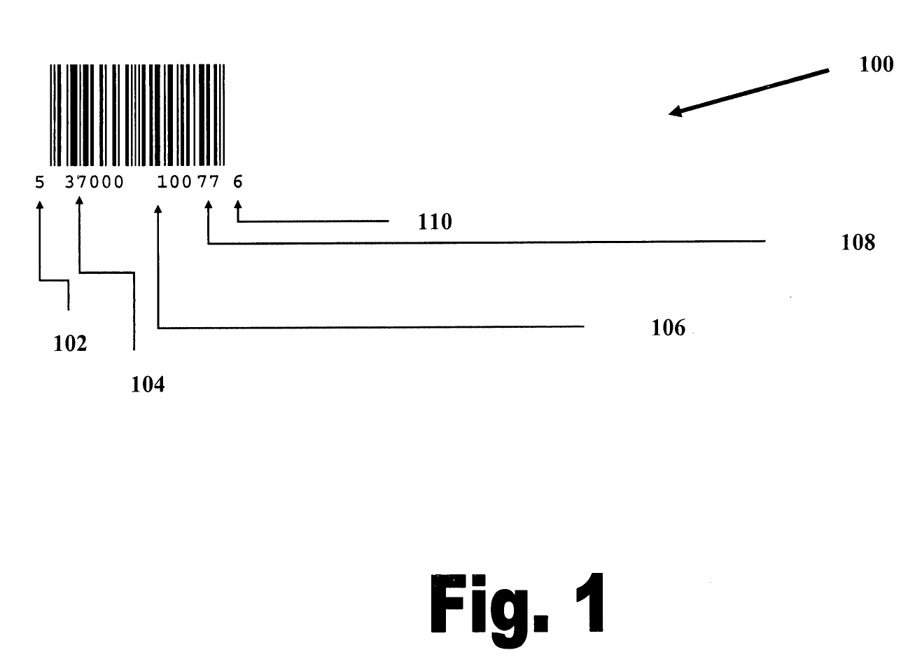

To expedite redemption of promotions, certificates representing promotions can have a bar code which provides certain information in machine readable form to scanners available, for example, at retailer stores. FIG. 1 is an exemplary illustration of a sample bar code 100 in accordance with the number system character (NSC) scheme. A type field 102 indicates the presence of the type of coupon. For example, a “5” indicates the presence of a manufacturer's coupon. A sponsor field 104 identifies the sponsor of the coupon, such as “37000” for Procter & Gamble of Cincinnati, Ohio. A family code field 106 indicates the family code of the item associated with the coupon. The family code field 106 in conjunction with the sponsor field 104 can identify a sponsor's product line. For example, a sponsor code of “37000” and a family code of “100” identify Proctor & Gamble's detergent line of products. A value code field 108 identifies the discount value of the coupon. Sample value codes can be determined by reference to the Universal Product Code (UPC) Application Standard for UCC Coupon Codes, published by the Uniform Code Council, Inc. (UCC), which is hereby incorporated herein by reference in its entirety for all purposes. For example, a value code of “77” is associated with a $1.25 discount. A modulus field 110 identifies a check digit in accordance with the standards promulgated by the UCC, which standards are hereby incorporated herein by reference in their entirety for all purposes.

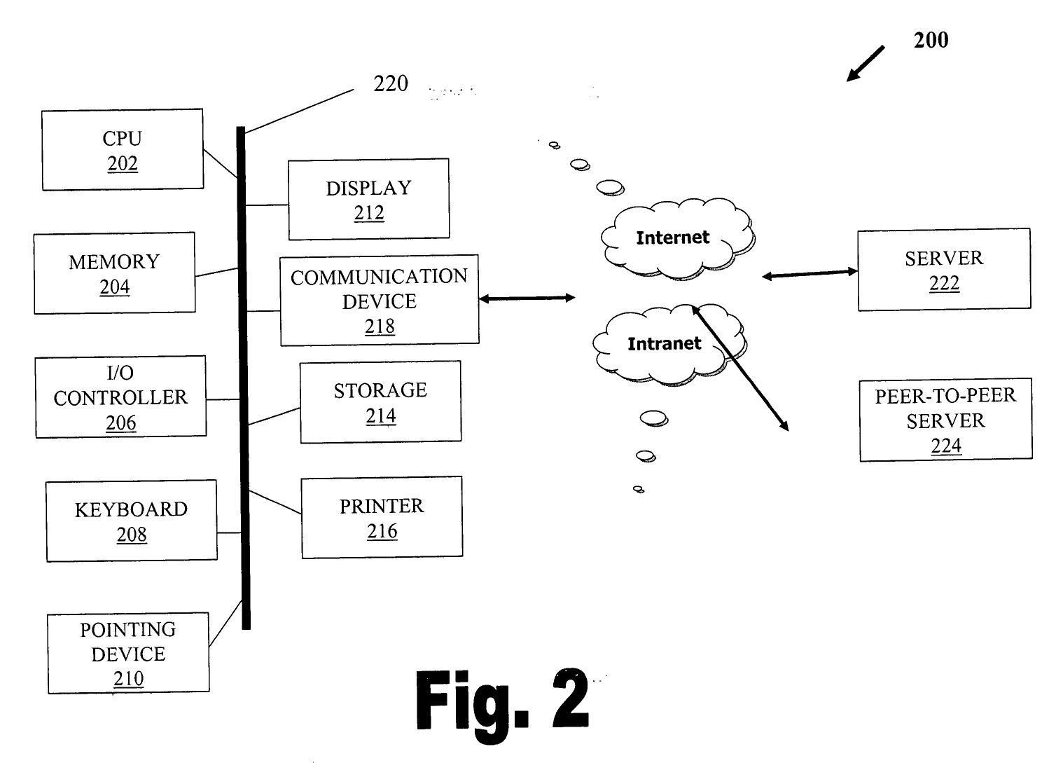

As shown in FIG. 2, the present invention may be embodied on a computer system such as a system 200, which comprises a central processing unit (CPU) 202, a main memory 204, an input/output controller 206, a keyboard 208, a pointing device 210 (e.g., mouse, track ball, pen device, or the like), a display device 212, and a mass storage 214 (e.g., hard disk, optical drive, or the like). Additional input/output devices, such as a printing device 216, may be included in the system 200 as desired. A communication device 218 can provide access to online services for example via the Internet or an intranet. The communication device 218 can be selected from a variety of devices such as an analog modem, a network card such as an Ethernet, Fast Ethernet, and Token Ring, a digital modem such as a digital subscriber line (DSL) and its varieties such as asynchronous DSL (ADSL), a wireless modem, and the like. The connection to the Internet and/or an intranet may provide access to a server 222 which can be any type of a server including a Web server, file transfer protocol (FTP) server, Novell® server, Sun® Microsystems, Inc. servers, and the like. As shown, access to a peer to peer server 224 can also be provided through the Internet and/or an intranet. As illustrated, the various components of the system 200 communicate through a system bus 220 or similar architecture. In an embodiment, the computer system 200 includes an IBM compatible personal computer, which is available from several vendors (including IBM of Armonk, N.Y.).

The communication via the Internet provides a number of new capabilities that can revolutionize the promotion industry. These advances can provide great benefits to consumers, marketers, retailers, and promotion services organizations. Among these ground breaking capabilities are:

Individualization

Targeting

Increased knowledge of consumer purchase behavior

Development of one to one consumer relationships

Continuity marketing and loyalty programs

24/7 consumer communication

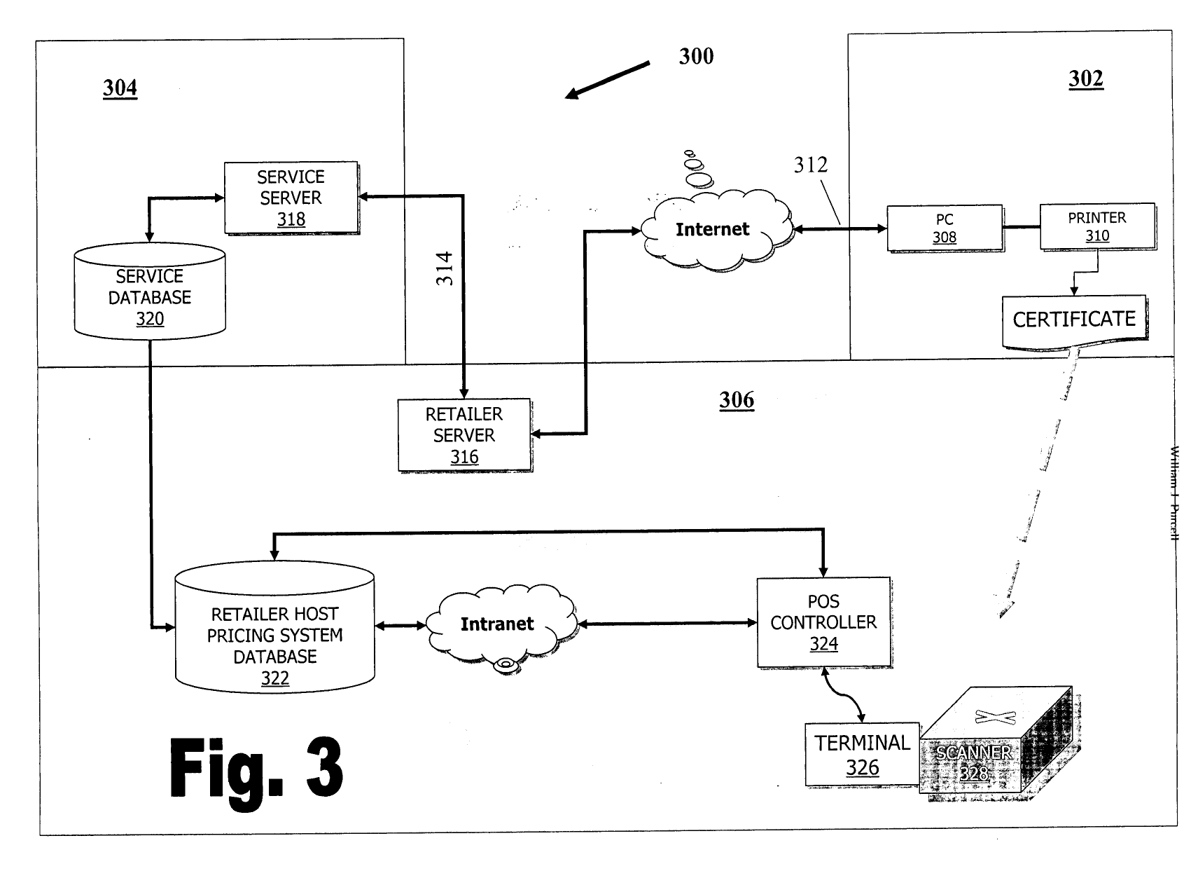

FIG. 3 is a simplified exemplary block diagram of a promotion system 300 in accordance with an embodiment of the present invention. The promotion system 300 includes a user location 302, a service location 304, and a retailer location 306. In its simplest form, the user location 302 can include a personal computer 308 (such as that discussed with respect to FIG. 2), a printer 310, and an Internet connection 312. The user location 302 can be coupled to the service location 304 or the retailer location 306 through, for example, the Internet or an intranet. The user location 302 can receive and send information from/to the service location 304 and the retailer location 306. In cases where the user location 302 is coupled to the retailer location 306, the retailer location 306 may send data from the user location 302 to the service location 304 via, for example, a connection 314. In such an implementation, the retailer location 306 may utilize a retailer server 316 for sending the data from the user location 302 to a service server 318 which can be coupled to a service database 320 at the service location 304. Alternatively, the retailer server 316 may be configured to directly communicate with the service database 320.

As illustrated in FIG. 3, the service database 320 can be coupled to a retailer host pricing system database 322. The retailer location 306 can also include a point of sale controller 324 that can communicate with the retailer host pricing database 322 directly or via an intranet. The point of sale controller can be coupled to a terminal 326. The terminal 326 can include other devices such as a scanner 328 and a printer (not shown).

Accordingly, a user can access the retailer server 316 or service server 318 to, for example, select offered promotions, which can be stored in the service database 320. The user can then either physically print out a certificate and take it to the retailer location 306 or electronically redeem the offer at the retailer location 306. Of course, those with ordinary skill in the art would understand that the actual location of individual elements of FIG. 3 can be modified without departing from the spirit of the present invention. It is also envisioned that the retailer location 306 may be an online store without traditional terminals and the like, instead utilizing electronic commerce technology.

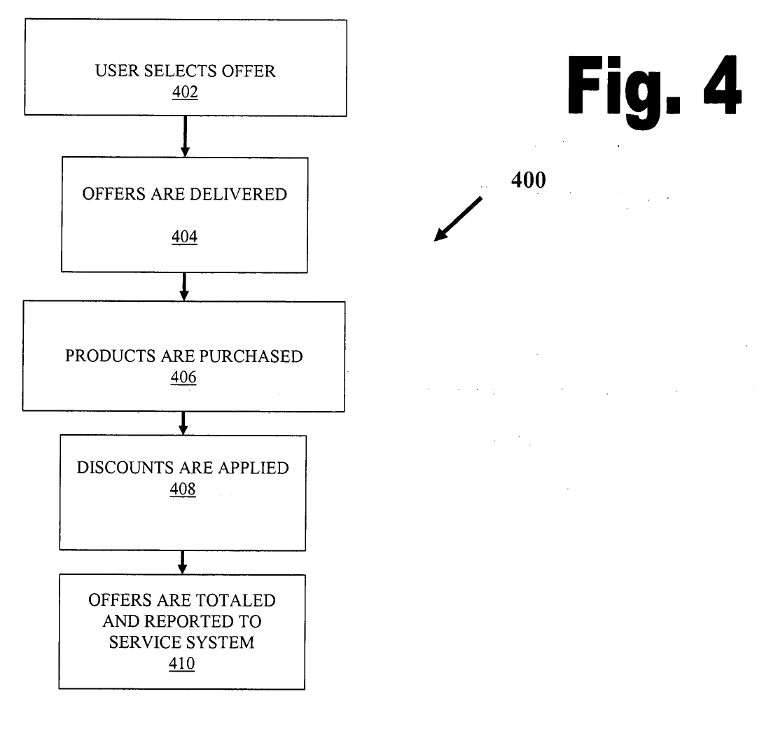

FIG. 4 is a simplified exemplary flow diagram of a method of secure promotion processing 400 in accordance with an embodiment of the present invention. In block 402, a user selects offers. The offers can be provided by a service system such as the service location 304 discussed with respect to FIG. 3. Selected offers can then be delivered to a retailer in step 404, such as the retailer location 306 of FIG. 3. In step 406, the products related to the selected offers of step 402 can be purchased either in person or electronically. It is envisioned that a purchase may include delivery of product samples in some embodiments. Step 408 provides the applicable discounts associated with the selected offers of step 402. In case of product samples, the discount can be the total price of a given product. In step 410, the offers are totaled and reported to a service system. The service system can be the service location 304 of FIG. 3. Alternatively, the service system may be a centralized entity such as a clearinghouse. Accordingly, the service system can be an electronic system or a paper based system.

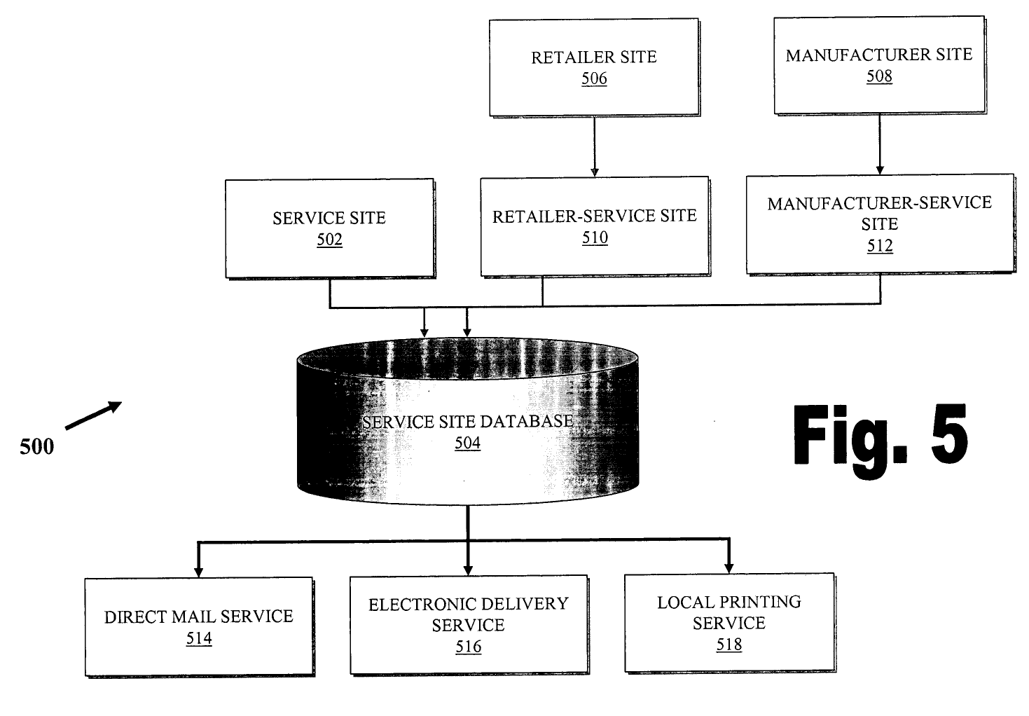

FIG. 5 is a simplified exemplary block diagram of a secure promotion delivery system 500 in accordance with an embodiment of the present invention. The illustrated secure promotion delivery system 500 includes a service site 502. The service site 502 can be a Web site. The service site 502 can provide a user interface (UI) for a user to select from a number of offers. The offers can include purchase incentives such as coupons, loyalty points, free product samples, and the like. The service site 502 may be, for example, similar to the service location 304 of FIG. 3. The service site 502 may be coupled to a service site database 504. The service site database 504 may be coupled to the service site 502 through various electronic communication means such as a local area network (LAN), a wireless network, the Internet, an intranet, a dial up connection, or a wide area network (WAN). Other sites such as a retailer site 506 or a manufacturer site 508 may also be coupled to the service site database 504 to provide offers to users. In some embodiments, the retailer site 506 and manufacturer site 508 may be coupled to the service site database 504 through a retailer service site 510 and a manufacturer service site 512, respectively. The retailer service site 510 and manufacturer service site 512 may provide a UI for the visitors to the retailer site 506 and the manufacturer site 508 to gain access to the offers and services provided through the service site database 504. For example, a user may be provided with a UI in a framed environment where the framed information is directly or indirectly provided by different entities such as the retailer service site 510 or the manufacturer service site 512.

After a user makes its promotion selections through the service site 502, retailer site 506, or manufacturer site 508, the service site database 504 can provide information for delivery of the selected promotions. For example, the selected promotions may be sent to the user via direct mail service 514. The direct mail service 514 may be selected from a variety of services such as those provided by the United States Postal Service including bulk mail, first class mail, and the like. Alternatively, the selected promotions may be sent to the location, whether online or in a brick and mortar store, via electronic delivery service 516. The electronic service 516 may for example, provide the promotions to the user by utilizing a retailer's frequent shopper card program. In a frequent shopper card program implementation, the selected promotions may be securely linked to the user's frequent shopper card number and redeemable by providing user identification at a retailer. The user identification may also be accomplished via other unique identifiers such as the user's phone number, social security, signature, voice recognition, and biometrics such as retina scans, fingerprints, and the like. Also, the user may utilize a local printing service 518 to print out a secure certificate on a printer which can then be presented at a retailer for redemption. The local printing service 518 may be selected from a number of options such as a local printer, a POS printer, a networked printer such as those connected to an intranet, a retail store printer, and the like.

In some embodiments, it may be more desirable to utilize the electronic delivery service 516 or the direct mail service 514 over the local printing service 518. This may be due to the fact that even legitimate user printed coupons can be prone to “Bad Scan” problems. This is often not due to the fault of the CPG marketer or the Internet coupon service, but rather due to the problems associated with most personal computer (PC) printing technology. For example, a low resolution of a user's printer or minor ink smudges, often unseen by the user, can each result in checkout scanning problems. These Bad Scans may create additional expenses to retailers in checkout labor, check stand supervision, accounting, and employee training, as well as potential “soft costs” associated with consumer and employee distrust of the POS system.

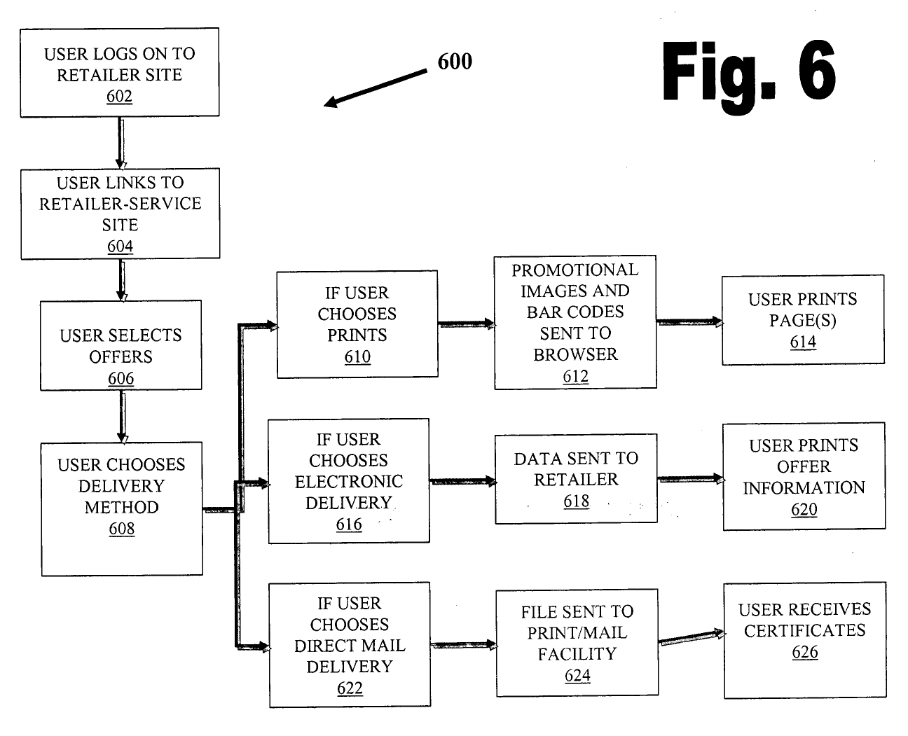

FIG. 6 is a simplified exemplary flow diagram of a method of secure promotion delivery 600 in accordance with an embodiment of the present invention. The method 600 includes step 602 wherein a user logs onto a retailer site, such as the retailer site 506 of FIG. 5. In an optional step 604, the retailer site may link the user to a retailer service site such as the retailer service site 510 of FIG. 5. In step 606, the user can select from offers from a plurality of promotional offers. In step 608, the user can choose a preferred delivery method for the selected promotions. For example, the user can choose to have the promotion delivered via printing (step 610), electronically (step 616), and/or via direct mail (step 622). In some embodiments, steps 610, 616, and 622 may correspond to services 518, 516, and 514 of FIG. 5, respectively.

If the user chooses printing (step 610), step 612 can send promotional images and/or bar codes to the user's browser or computing device. The promotional images can include a picture of the product being promoted together with a description and pricing information. In step 614, the user may elect to print the sent information on a printer. If the user chooses electronic delivery (step 616), step 618 can send promotional information (such as a data file) to a retailer computer, such as a retailer server that can communicate with that retailer's sales apparatus (in case of retail stores often a POS terminal). In an optional step 620, the user may elect to print information regarding the offers on a printer. The printed information can be a summary of offers, location of products within the store, which can be a map in case of retail stores or a link in case of online retailers. Alternatively, if the user chooses direct mail delivery (step 622), step 624 can send promotional information (such as a data file) to a print/mail facility, in an embodiment, a secure communication means, such as a dedicated T-1 line or WAN connection, can be provided to the print/mail facility. In step 626, the user receives the certificates via direct mail. The received certificates can then be used to obtain discounts at a retailer, whether online (for example, by utilizing certificate codes) or in a store.

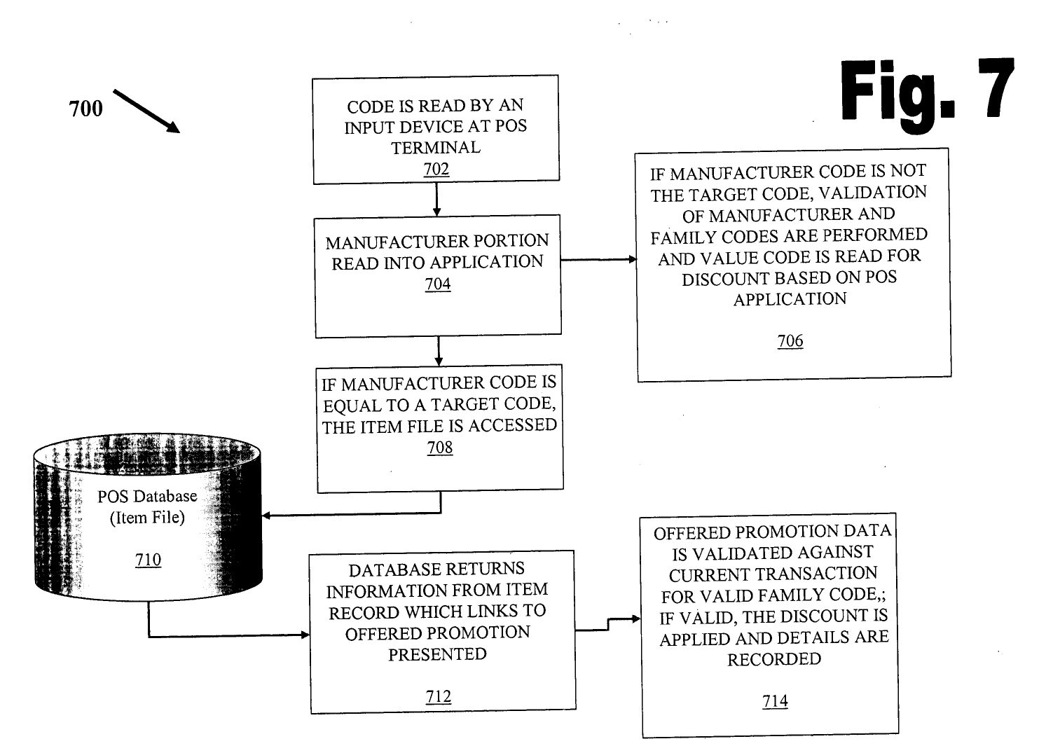

FIG. 7 is a simplified exemplary block diagram of a secure promotion redemption system 700 in accordance with an embodiment of the present invention. In step 702, a code is read by an input device, such as a scanner (e.g., the scanner 328 of FIG. 3) at a POS such as the terminal 326 of FIG. 3. The code can be any representation including a UCC bar code, an encrypted code, a two dimensional bar code, and the like. In an embodiment, the code may be a UCC bar code such as that discussed with respect to FIG. 1. Step 704 reads the manufacturer portion of the code for analysis. If the manufacturer portion of the code is not equal to a target code, step 706 validates the manufacturer and family code portions and determines a value code for a discount based on information stored within the POS application. Alternatively, if the manufacturer portion of the code is equal to the target code, in step 708, an item file is accessed for the specific record. The item file can include data such as a specific price discount, loyalty point award information, any limitations or quantity requirements needed for validation, and the like. The item file may also contain manufacturer and family code data which may be required for validation. The item file can be, for example, stored in a POS database 710. The item file can itself be a database. Alternatively, other local or remote databases can be utilized for storage of the item file.

In step 712, the POS database 710 can return the information from the item record that corresponds to the offered promotion. The item file can have any record number. Generally, in the widely deployed IBM 4690 POS system, the default range for the item records in the item file is from 40000 00000 to 40000 99999. The details of the IBM 4690 system can be found in manuals published by the IBM Corporation, which are hereby incorporated herein by reference. In some implementations for UCC bar coded promotions, the last five digits of the barcode can be utilized to link to the offered promotion at the POS. A step 714 can validate the offered promotion data against the current transaction, for example, for valid family code. If the family code of the presented promotion is valid, the promotion can then be applied and the transaction details stored in the transaction log of the POS system. Even though the above description of FIG. 7 discusses a POS system, it is envisioned that in case of online retailers an electronic commerce system can readily replace the POS system functionality.

The recorded transaction log information can also store identification indicia from the presented promotional certificate, whether in electronic or physical formats. Alternatively, the identification indicia can be obtained from other sources such as a user identity card (such as a frequent shopper card), the user's home number, a secret code, a smart card, and the like. The stored identification indicia can be utilized to link the purchase or redemption activities of the user. For example, after the purchased items are scanned (or selected online), the identity of the user can be validated to see if that user has any offers outstanding, previously redeemed the promotional offer, exceeded the user's offer limits, and the like. The indicia can also be utilized to update records such as a loyalty point program.

This data can be stored either integrally within the existing databases or within external databases (whether on site or accessible through a computer network). The data can also be periodically updated or be always linked through real time electronic connections. In an implementation with separate databases, it is envisioned that the POS system can have access to any number of databases including a transaction log database (which can store data regarding transactions, and the like), an item file (which can contain data regarding the items available for purchase), an offer database (which can include data regarding available promotional offers), and a user database (which can store data regarding the user including account numbers, store credit account balances, loyalty program balances, frequent shopper information, contact information, and/or the like).

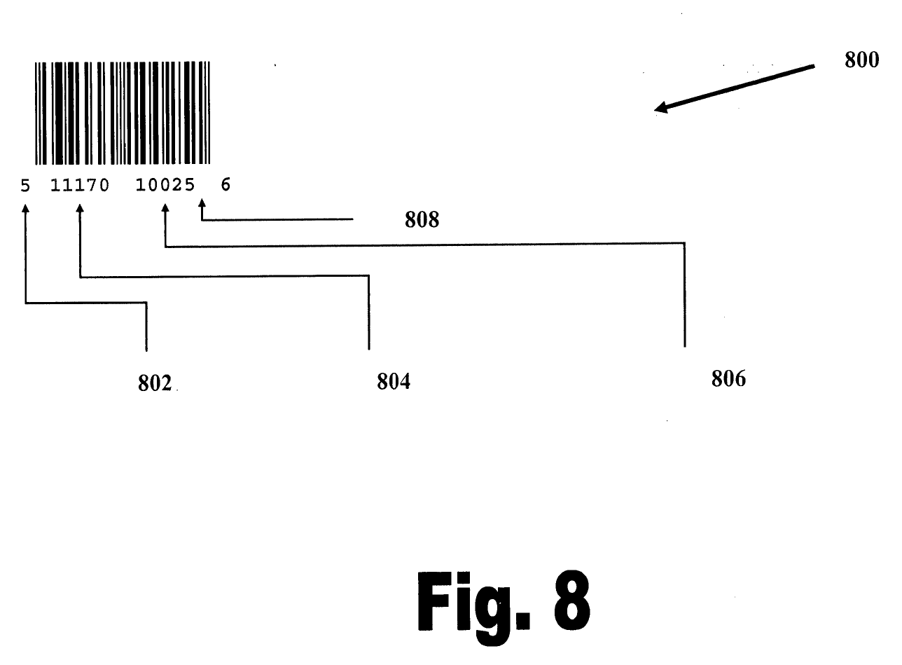

FIG. 8 is a simplified exemplary illustration of a secure NSC bar code 800 for a sample certificate in accordance with an embodiment of the present invention. A type field 802 indicates the presence of the type of certificate. For example, a “5” indicates the presence of a manufacturer's coupon. A locally assigned field 804 can identify a locally assigned code (e.g., 11170) which recognizes this bar code as a special promotion requiring an item record lookup, such as that discussed with respect to FIG. 7. A specific promotion field 806 can indicate the specific promotion related to the looked up item record. For example, by referring to the item record 40000 10025 in an IBM 4690 POS system, the offered promotion value and requirements can be retrieved. A modulus field 808 can identify a check digit in accordance with the standards promulgated by the UCC, which standards are hereby incorporated herein by reference in their entirety for all purposes. In some embodiments, the modulus field 808 can be utilized for error detection and correction, for example, for hardware devices such as barcode readers.

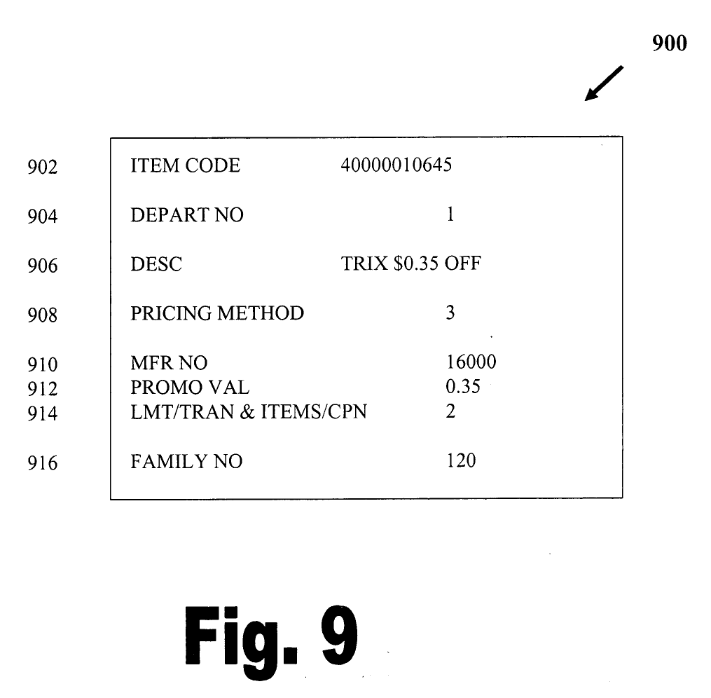

FIG. 9 is a simplified exemplary block diagram of an item record 900 in accordance with embodiments of the present invention. An item code field 902 stores an item code which can be extracted from the physical or electronic certificate, such as that discussed with respect to FIG. 8. A department number field 904 can include identifications for the department where the offer is redeemable or offered, such as meats, fresh produce, baby seats, women's clothing, and the like. A description field 906 can store human readable information for reference of the store personnel or user. A pricing method field 908 can identify the type of pricing for the offer (e.g., unit priced coupon, tiered pricing, and the like). A manufacture number field 910 can identify the item's manufacturer, such as 16000 for General Mills, Inc. A promo value field 912 can indicate the amount of the offer. For example, “0.35” can indicate that the user is entitled to thirty five cents off of the purchase price. A limit field 914 can indicate how many items can be purchased with the same discount value. For example, a “2” can indicate that the user is entitled to discounts on two of the items covered by the present item record. A family number field 916 can contain data that identifies the family of the manufacturer's products for the manufacturer identified by field 910. In some embodiments, the family code can be a three digit number where each digit can refer to product categories, subcategories, and the like. For example, “100” may refer to all detergents, “110” may refer to all household detergents, “120” may refer to automobile detergents, and “111” may refer to household dishwashing detergents.

In addition to the fields identified with respect to FIG. 9, other fields may be present in the item record, such as fields to keep information about the product inventory, weight/price requirements, item type (e.g., normal sale, deposit, refund, deposit return, manufacturer coupon, store coupon, and the like), loyalty points, and the like. Moreover, a user field (not shown) can include information about the users who are entitled to redeem the promotion. This field can alternatively be a link to a local or remote database where such data is kept.

While the invention has been described with reference to the illustrated embodiments, this description is not intended to be construed in a limiting sense. Various modifications of the illustrated embodiment as well as other embodiments of the invention will become apparent to those persons with ordinary skill in the art upon reference to this description. For example, a wireless device can be used to provide a seamless communication interface. Also, the UI may be provided via Email, interactive banner ads, interactive cable or satellite TV, cell phones, wireless devices, Internet appliances, Web based in store kiosks or displays, and the like. Furthermore, marketers can include recipes and other “brand building” marketing messages with the promotional offers. It will be, therefore, understood that the invention is defined not by the above description, but by the appended claims.

We claim:

1. A method of providing a promotion to a user comprising:
providing the user with the promotion;
determining whether the user has selected the promotion;
if the user has selected the promotion, informing a retailer about the selected promotion;
determining whether the selected promotion is being redeemed at the retailer;
if the selected promotion is being redeemed at the retailer, determining whether the selected promotion corresponds to the promotion being redeemed; and
if the selected promotion corresponds to the promotion being redeemed, providing the user with the promotion.

2. The method of claim 1 further including the act of providing the user with a promotion receipt.

3. The method of claim 2 wherein the promotion receipt indicates the physical location of an item corresponding to the promotion.

4. The method of claim 2 wherein the promotion receipt includes directions to the store carrying an item corresponding to the promotion.

5. The method of claim 4 wherein the directions is selected from a group comprising maps and URLs.

6. The method of claim 1 wherein the act of informing a retailer about the selected promotion includes sending the retailer a promotion identifier.

7. The method of claim 6 wherein the promotion identifier corresponds to an item record.

8. The method of claim 7 wherein the item record is stored in a database.

9. The method of claim 1 wherein the act of determining whether the selected promotion corresponds to the promotion being redeemed further includes:
checking a first portion of a promotion identifier;
if the first portion of the promotion identifier matches a target code, extracting a second portion of the promotion identifier; and
accessing information within an item record associated with the second portion of the promotion code and including information regarding the promotion.

10. The method of claim 9 wherein the item record includes information selected from a group comprising an item code, department number, pricing method, description, manufacturer number, promotion value, limitations, and family code.

11. A method of delivering a secure promotion to a user comprising:
a. collecting a plurality of offers;
b. assigning a unique identifier to each of the offers from the plurality of offers;
c. providing a retailer with the plurality of offers;
d. identifying the user;
e. providing the user with a portion of the plurality of offers for selection;
f determining which of the provided offers the user has selected;
g. informing the retailer about the selected offers by the user;
h. validating the selected offers;
i. redeeming the selected offers; and
j. providing a clearinghouse with the redemption information.

12. The method of claim 11 wherein the clearinghouse performs acts a through g.

13. The method of claim 11 wherein the act of identifying the user is accomplished through information selected from a list comprising name, address, email address, social security number, biometrics, and frequent shopper number.

14. The method of claim 11 wherein the unique identifier identifies both the offer and the user.

15. The method of claim 11 wherein the unique identifier is encoded.

16. The method of claim 15 wherein the unique identifier is encoded utilizing techniques selected from a list comprising bar coding, UPC encoding, and encryption.

17. The method of claim 11 wherein the offers are selected from a group comprising coupons, certificates, product samples, airline tickets, and gift certificates.

18. The method of claim 11 wherein informing the retailer is accomplished by a technique selected from a list comprising a user printed certificate, a frequent shoppers card, a frequent shopping number, and a securely printed certificate.

19. The method of claim 11 wherein the retailer is selected from a group comprising a grocery store, a convenience store, an travel agent, a kiosk, an authorized dealer, an online retailer, and a manufacturer.

20. A system for provision of a secure promotion to a user comprising:
a user location configured to provide the user with access to the secure promotion;
a service location coupled to the user location, the service location configured to provide options to the user regarding the secure promotion;
a retailer location coupled to the service location, the retailer location configured to receive the secure promotion; and
a unique id code associated with the secure promotion, the unique id code having a first and second portions, the first portion of the unique id code indicating whether the secure promotion is a special promotion, the second portion of the unique id code indicating a link to an item record, the item record having fields comprising data regarding an item associated with the secure promotion,
wherein the user receives benefits of the secure promotion by provision of the unique id code to the retailer.

21. The system of claim 20 wherein the retailer location includes a POS terminal.

22. The system of claim 21 wherein the POS terminal is coupled to a bar code scanner.

23. The system of claim 20 wherein the user, service, and retailer locations are coupled via a connection selected from a group comprising the Internet, an intranet, a WAN, a LAN, a broadband connection, and a wireless connection.
